(19) United States
(12) Patent Application Publication
(10) Pub. No.: US 2020/0295566 A1
(43) Pub. Date: Sep. 17, 2020

(54) ENERGY STORAGE SYSTEM CONTROL METHOD AND APPARATUS FOR PEAK POWER SHAVING

(71) Applicant: ELECTRONICS AND TELECOMMUNICATIONS RESEARCH INSTITUTE, Daejeon (KR)

(72) Inventors: Hong Soon NAM, Daejeon (KR); Youn Kwae JEONG, Daejeon (KR)

(21) Appl. No.: 16/662,210

(22) Filed: Oct. 24, 2019

(30) Foreign Application Priority Data
Mar. 12, 2019 (KR) 10-2019-0028208

(51) Int. Cl. H02J 3/24; G05F 1/66; F03D 7/04

(52) U.S. Cl. CPC H02J 3/24; F03D 7/045; G05F 1/66

(57) ABSTRACT

A peak power controlling method for a zero energy town (ZET) includes scheduling control power of an energy storage system (ESS) for each time period based on time-varying electric rate information of a grid, monitoring a power consumption of the ZET, and determining control power of the ESS based on a result of the scheduling and a result of comparing the monitored power consumption of the ZET and a preset threshold value.

### CROSS-REFERENCE TO RELATED APPLICATION(S)

This application claims the priority benefit of Korean Patent Application No. 10-2019-0028208, filed on Mar. 12, 2019, in the Korean Intellectual Property Office, the disclosure of which is incorporated herein by reference for all purposes.

### BACKGROUND

### 1. Field of the Invention

One or more example embodiments relate to a method and apparatus for controlling peak power of a zero energy town (ZET).

### 2. Description of Related Art

A zero energy building (ZEB) may be constructed to realize an average annual power consumption of zero, using distributed energy resources such as environmentally-friendly energy sources. However, a ZEB may require a high cost for construction, and not realize zero energy depending on a building environment. Thus, a zero energy town (ZET), which is a new concept expanded from such existing concept of ZEB, has been introduced to resolve such issues arising from the ZEB.

A ZET may control its power consumption through distributed energy resources in the ZET and a grid to realize an average zero power consumption annually in the ZET in which ZEBs, non-ZEBs, residential buildings, and non-residential building are present.

A smart grid that may be used for such ZET refers to a system that is configured to control power supply by proving a power supplier and producer with information on users of electric power, and is constructed by applying information and communication technology to a power system to provide high-quality power services.

### SUMMARY

According to an example embodiment, there is provided a peak power controlling method for a zero energy town (ZET), the peak power controlling method including scheduling control power of an energy storage system (ESS) for each time period based on time-varying electric rate (e.g., time-of-use (TOU) or real-time price (RTP)) information of a grid, monitoring a power consumption of the ZET, and determining control power of the ESS based on a result of the scheduling and a result of comparing the power consumption of the ZET and a preset threshold value.

The scheduling may include scheduling the control power to charge the ESS in a time period in which an electric rate is less than or equal to a first threshold value.

The scheduling may include scheduling the control power to discharge the ESS in a time period in which the electric rate is greater than or equal to a second threshold value.

The determining of the control power may include determining the control power such that the ESS releases energy stored therein, in response to the power consumption being greater than or equal to a third threshold value.

The determining of the control power may include determining the control power such that the ESS is charged, in response to the power consumption being less than or equal to a fourth threshold value.

The determining of the control power may include determining the control power based on the result of the scheduling, in response to the power consumption being less than the third threshold value and greater than the fourth threshold value.

The determining of the control power may include determining the control power based on at least one of a change in power consumption, the result of the scheduling, a proportional constant, or power of the ESS at an immediately preceding point in time.

The proportional constant may be determined based on a state of charge (SOC) of the ESS.

According to another example embodiment, there is provided a peak power controlling apparatus configured to control peak power of a ZET and a grid, the peak power controlling apparatus including a memory and a processor. The processor may be configured to schedule control power of an ESS for each time period based on time-varying electric rate information of the grid, monitor a power consumption of the ZET, and determine control power of the ESS based on a result of the scheduling and a result of comparing the power consumption of the ZET and a preset threshold value.

The processor may be configured to schedule the control power to charge the ESS in a time period in which an electric rate is less than or equal to a first threshold value.

The processor may be configured to schedule the control power to discharge the ESS in a time period in which the electric rate is greater than or equal to a second threshold value.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of an overall configuration of a zero energy town (ZET) according to an example embodiment;

FIG. 2 is a flowchart illustrating an example of a peak power controlling method according to an example embodiment;

FIGS. 3A and 3B are diagrams illustrating an example of a method of scheduling control power of an energy storage system (ESS) based on a time-of-use (TOU) rate according to an example embodiment;

FIG. 3C is a flowchart illustrating an example of a method of scheduling control power of an ESS according to an example embodiment;

FIG. 4 is a diagram illustrating an example of a method of controlling peak power by monitoring a power consumption of a ZET according to an example embodiment;

FIG. 5 is a flowchart illustrating an example of a method of controlling peak power by monitoring a power consumption of a ZET according to an example embodiment;

FIGS. 6A, 6B, and 6C are example graphs obtained by applying a peak power controlling method according to an example embodiment; and

FIG. 7 is a diagram illustrating an example of a peak power controlling apparatus according to an example embodiment.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings.

A zero energy town (ZET) is constructed to realize a zero energy consumption of zero energy buildings (ZEBs), non-ZEBs, and residential or non-residential buildings, and a zero annual average power consumption for electric power produced through a distributed energy resource (DER) and electric power transferred through a grid. Hereinafter, electric power or energy will be simply or interchangeably referred to as “power.”

An amount of power needed in a ZET may vary depending on season, weather, and the like, and thus the grid may need to maintain a preset or higher level of reserve power to stably supply power to customers or consumers. When peak power increases on a customer side, the grid may need to secure a higher level of reserve power. Thus, the grid may need to be equipped with power generating, and transmitting and distributing installations of greater capacities. However, securing the reserve power and constructing such large-capacity installations may increase a unit cost of power, and the increased unit cost may fall to a share consumers need to pay for.

In addition, a monthly electric cost, or a monthly electric bill, is typically calculated as represented by Equation 1 below, and thus an increase in peak power may increase a monthly electric cost to be paid by a consumer.

Monthly electric cost=C_{base}Pₚₑₐₖ+ΣC_{usage,i}E_{usage,i} [Equation 1]

In Equation 1, C_{base} denotes a base rate per unit energy (Korean won [KRW]/kilowatt [kW]). Pₚₑₐₖ denotes 15-minute average power (kW) that peaks over the recent 12 months. C_{usage,i} and E_{usage,i} denote a time-varying electric rate (KRW/kilowatt-hour [kWh]) and electric power usage or a power consumption in a time period i, respectively.

In detail, as represented by Equation 1, the monthly electric cost may consist of a demand charge (C_{basic}Pₚₑₐₖ) and an energy charge (C_{usage,i}E_{usage,i}). The demand charge may be determined based on peak power for a predetermined period of time of a customer and base rate. The energy charge (C_{usage,i}E_{usage,i}) may be determined based on the time-varying electric rate (C_{usage,i}) and electric usage in the time period. On the other hand, the time-varying electric rate (C_{usage,i}) may be determined based on real-time peak power of the grid. Thus, controlling peak power of the grid and peak power of the customer may minimize an electric cost to be incurred.

A ZET may receive energy from an external grid in case of a lack of energy used in the ZET, and transmit energy to the external grid in case of an excess of energy. In such process, the ZET may use an energy storage system (ESS) included in the ZET to control peak power of the ZET. In detail, during such power transmission and reception between the ZET and the grid, peak power of the ZET may be controlled to be a desirable level by charging or discharging the ESS depending on a situation.

According to an example embodiment, a peak power controlling apparatus may control peak power of a grid by scheduling charging or discharging of an ESS based on a time-varying electric rate, and control peak power of a ZET by monitoring a power consumption of the ZET and adjusting control power of the ESS.

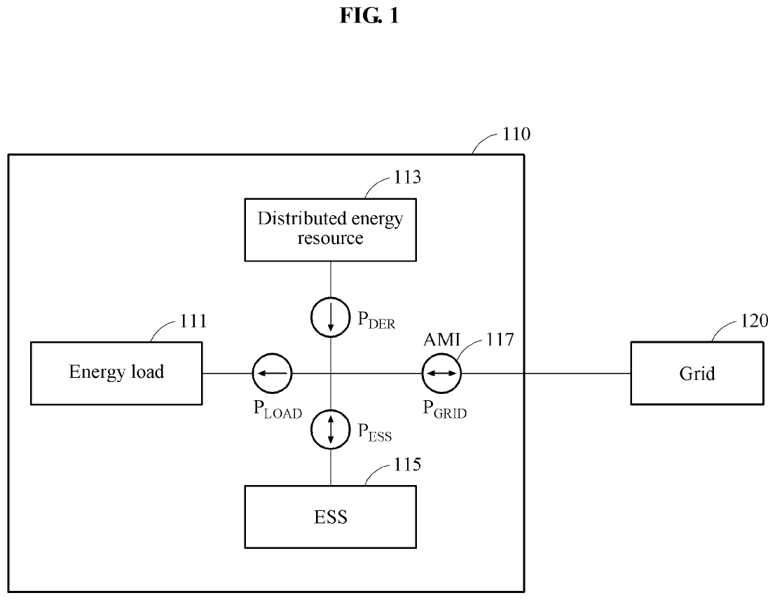

FIG. 1 is a diagram illustrating an example of an overall configuration of a ZET according to an example embodiment.

Referring to FIG. 1, a ZET 110 includes an energy load 111 including zero energy buildings (ZEBs), non-ZEBs, and residential and non-residential buildings, and the like that consume electric power. The ZET 110 produces energy to be used by the energy load 111 through a distributed energy resource 113 such that an annual average power consumption or usage of the entire town is zero. The distributed energy resource 113 may be an environmentally-friendly power generation facility including, for example, a solar energy generation facility, a wind power generation facility, and the like. When power used by the energy load 111 is greater than power produced by the distributed energy resource 113, the ZET 110 balances supply and demand of power through an ESS 115 or a grid 120. When power used by the energy load 111 is less than power produced by the distributed energy resource 113, the ZET 110 provides such surplus power to the ESS 115 or the grid 120. Thus, the ZET 110 may realize zero energy. Even though the zero energy is realized through the ESS 115 and the grid 120, reserve or backup power facilities and power transmission and distribution facilities of large capacity may be needed in preparation for peak power. However, such facilities may increase a unit cost for electric power.

According to an example embodiment, a peak power controlling apparatus may monitor, in real time, a power consumption of a ZET through an advanced metering infrastructure (AMI), and determine control power of an ESS based on a result of the monitoring, thereby maintaining peak power of the ZET or a grid within a predetermined range.

In addition, the peak power controlling apparatus may schedule control power of the ESS for each time period based on a time-varying electric rate, and thus control the peak power of the grid.

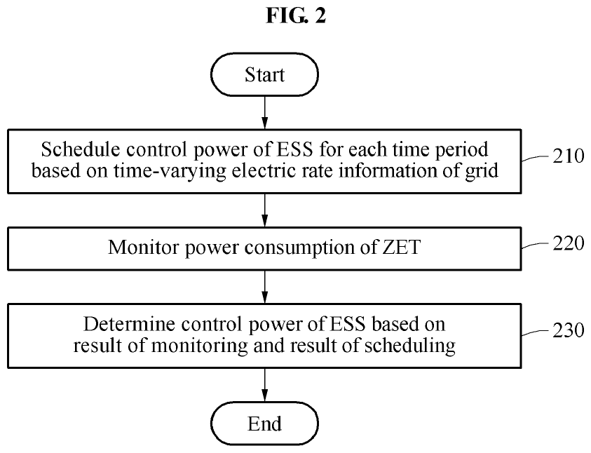

FIG. 2 is a flowchart illustrating an example of a peak power controlling method according to an example embodiment.

Referring to FIG. 2, in operation 210, a peak power controlling apparatus schedules control power of an ESS for each time period based on time-varying electric rate information of a grid.

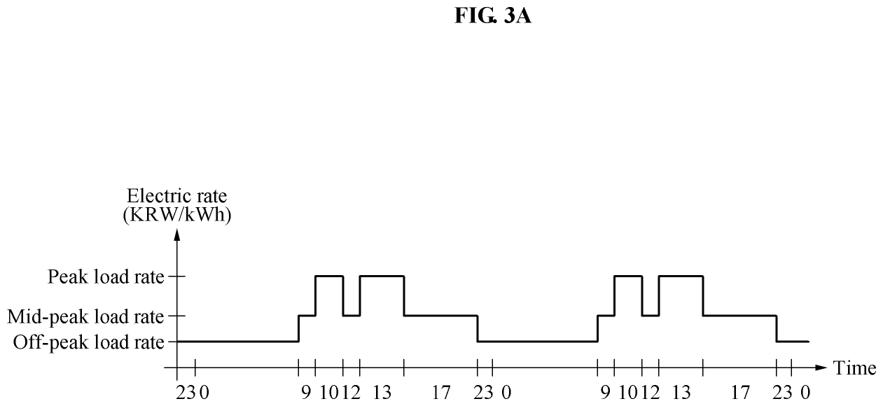

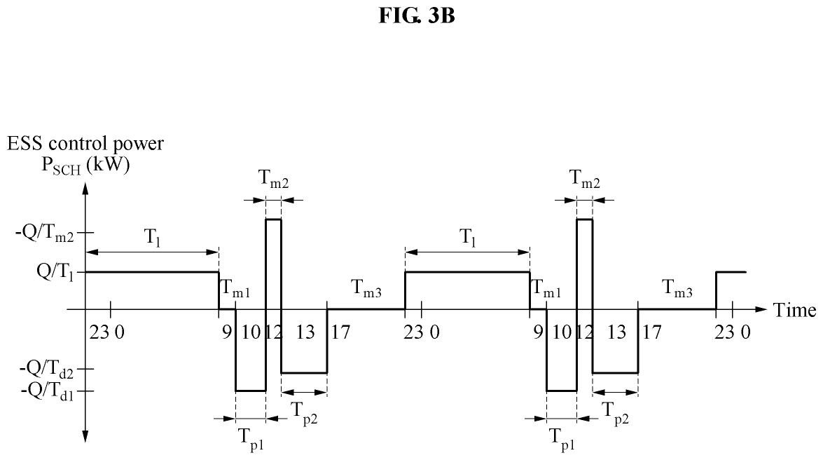

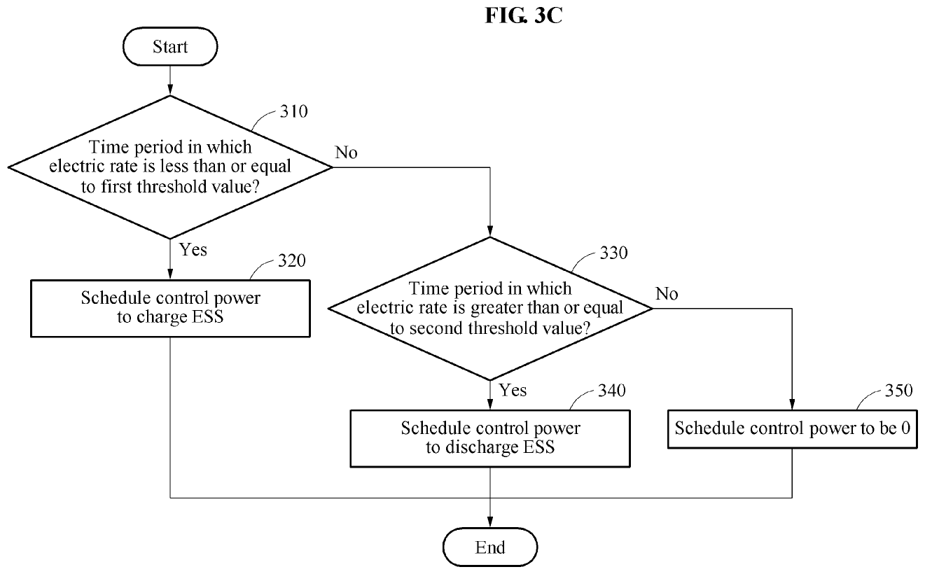

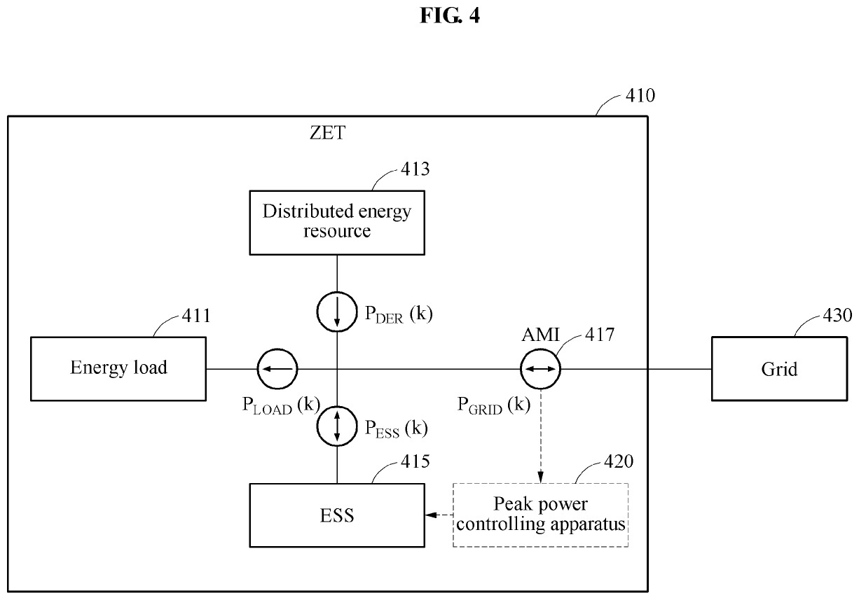

The peak power controlling apparatus may schedule the control power such that the ESS is charged in a time period in which an electric rate is less than or equal to a first threshold value, and the ESS is discharged in a time period in which an electric rate is greater than or equal to a second threshold value. Through this, the peak power controlling apparatus may charge the ESS when an electric rate offered by the grid is relatively low (or cheap) and discharge ESS when an electric rate offered by the grid is relatively high (or expensive), and may thus minimize an electric consumption or usage at a peak time. Hereinafter, a detailed method of scheduling control power of the ESS will be described with reference to FIGS. 3A through 4.

In operation 220, the peak power controlling apparatus monitors a power consumption of a ZET. The peak power controlling apparatus monitors, in real time, a power consumption of the ZET through an AMI.

In operation 230, the peak power controlling apparatus determines control power of the ESS based on a result of the scheduling and a result of comparing the power consumption of the ZET and a preset threshold value.

When the power consumption is greater than or equal to a third threshold value, the peak power controlling apparatus may determine the control power such that the ESS releases energy stored therein.

When the power consumption is less than or equal to a fourth threshold value, the peak power controlling apparatus may determine the control power such that the ESS is charged.

When the power consumption is less than the third threshold value and greater than the fourth threshold value, the peak power controlling apparatus may determine the control power based on the result of the scheduling.

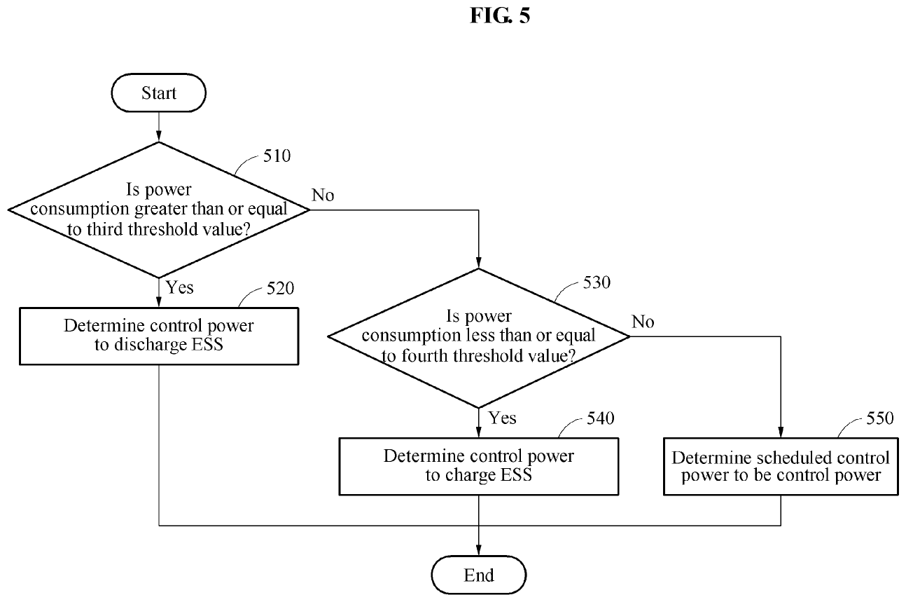

The peak power controlling apparatus may manage peak power of the ZET more effectively by controlling power based on an electric rate, or an electric bill, and monitoring a power consumption of the ZET, and controlling the ESS based on a result of comparing the monitored power consumption and a preset threshold value. Hereinafter, a detailed method of controlling peak power of a ZET by monitoring a power consumption of the ZET will be described with reference to FIGS. 4 and 5.

FIGS. 3A and 3B are diagrams illustrating an example of a method of scheduling control power of an ESS based on a time-varying electric rate according to an example embodiment. Herein, the time-varying electric rates includes time-of-use (TOU), critical peak pricing and real-time price. TOU typically consists of several time periods, peak load time, mid-load time and off peak load time, in which electric rates are different depending on load states.

Referring to FIG. 3A, an electric rate provided by a grid may change based on a demand for electricity in each time period. For example, as illustrated, an electric rate is determined to be commensurate with a peak load rate in a time period between 10 am and 12 pm in which electricity is in high demand, and an electric rate is determined to be commensurate with a off-peak load rate in a time period between 23 pm and 9 am of the next day in which electricity is in low demand.

It is possible to operate an ESS effectively with a maximum gain by charging the ESS in the time period between 23 pm and 9 am of the next day corresponding to the off-peak load rate, discharging the ESS in the time period between 10 am and 12 pm corresponding to the peak load rate, charging the ESS in a time period between 12 pm and 13 pm corresponding to an mid-peak load rate, and discharging the ESS in a time period between 13 pm and 17 pm corresponding to the peak load rate, based on the TOU rate as illustrated in FIG. 3B.

In a process in which the ESS is charged or discharged, it may be effective to charge or discharge energy by an amount of Q which is a capacity of the ESS. Thus, scheduled control power P_{SCH} of the ESS may be determined based on a capacity Q of the ESS and a charging or discharging time T.

FIG. 3C is a flowchart illustrating an example of a method of scheduling control power of an ESS according to an example embodiment.

Referring to FIG. 3C, in operation 310, a peak power controlling apparatus determines a time period in which an electric rate is less than or equal to a first threshold value. In operation 320, in response to a determination of the time period in which the electric rate is less than or equal to the first threshold value, the peak power controlling apparatus schedules control power of an ESS to charge the ESS.

The peak power controlling apparatus determines scheduled control power P_{SCH}(k) as represented by Equations 2 and 3.

P_{SCH_T}(k)={Q−q(k)}/t_{CHG}(k) [Equation 2]

In Equation 2, P_{SCH_T}(k) denotes potentially scheduled control power, and Q denotes a charge capacity of the ESS. q(k) denotes a current charge amount, and t_{CHG}(k) denotes a remaining charge time.

$${P}_{SCH} ( k ) = min \{ {P}_{SCH} ( k - 1 ) + \frac{{P}_{SCH \_ T} ( k )}{n} , {P}_{SCH \_ T} ( k ) \} \qquad [ Equation 3 ]$$

In Equation 3, P_{SCH}(k) denotes scheduled control power, and n denotes a natural number.

In addition, t_{CHG}(k) denotes a remaining charge time. When charging is performed for t_{CHG}(k), the ESS may be charged by Q which is a capacity of the ESS. For example, when the ESS is scheduled to be charged by 9 am on the next day, and a current time is 23 pm, t_{CHG}(k) is 10 hours.

n may prevent P_{SCH}(k) from increasing rapidly. For example, when n is 3, P_{SCH}(k) may become similar to P_{SCH_T}(k) by performing Equation 2 three times.

In operation 330, the peak power controlling apparatus determines a time period in which an electric rate is greater than or equal to a second threshold value. In operation 340, in response to a determination of the time period in which the electric rate is greater than or equal to the second threshold value, the peak power controlling apparatus schedules control power of an ESS to discharge the ESS.

The peak power controlling apparatus determines scheduled control power P_{SCH}(k) as represented by Equations 4 and 5.

P_{SCH_T}(k)=−{Q−q(k)}/t_{DCHG}(k) [Equation 4]

In Equation 4, P_{SCH_T}(k) denotes potentially scheduled control power, and Q denotes a charge capacity of the ESS. q(k) denotes a current charge amount, and t_{DCHG}(k) denotes a remaining discharge time.

$${P}_{SCH} ( k ) = max \{ {P}_{SCH} ( k - 1 ) + \frac{{P}_{SCH \_ T} ( k )}{n} , {P}_{SCH \_ T} ( k ) \} \qquad [ Equation 5 ]$$

In Equation 5, P_{SCH}(k) denotes scheduled control power, and n denotes a natural number.

Equation 4 corresponding to discharging has a sign opposite to that of Equation 2 corresponding to charging, and a minus sign is used as the sign in the Equation 4.

In addition, t_{DCHG}(k) denotes a remaining discharge time. When discharging is performed for t_{DCHG}(k), the ESS may be discharged by Q which is a capacity of the ESS. For example, when the ESS is scheduled to be discharged by 9 am on the next day, and a current time is 23 pm, t_{DCHG}(k) is 10 hours.

n may prevent P_{SCH}(k) from increasing rapidly. For example, when n is 3, P_{SCH}(k) may become similar to P_{SCH_T}(k) by performing Equation 4 three times.

In operation 350, in a time not available for charging or discharging, the peak power controlling apparatus sets P_{SCH}(k) to be 0.

FIG. 4 is a diagram illustrating an example of a method of controlling peak power by monitoring a power consumption of a ZET according to an example embodiment.

In the example of FIG. 4, a peak power controlling apparatus 420 monitors, in real time, power used in a ZET 410 through an AMI 417. Here, power P_{TOWN}(k) used in the ZET 410 is determined based on a sum of power P_{LOAD}(k) used in an energy load 411, power P_{DER}(k) produced in a distributed energy resource 413, and power P_{ESS}(k) of an ESS 415.

P_{TOWN}(k) may be a positive value when power is flowed in from a grid 430, and a negative value when energy is sent out to the grid 430.

P_{TOWN}(k)=P_{LOAD}(k)+P_{DER}(k)+P_{ESS}(k) [Equation 6]

The peak power controlling apparatus 420 controls charging or discharging of the ESS 415 based on a result of the monitoring, and thus controls peak power of the ZET 410. How the peak power controlling apparatus 420 operates will be described in greater detail with reference to the following drawings.

FIG. 5 is a flowchart illustrating an example of a method of controlling peak power by monitoring a power consumption of a ZET according to an example embodiment.

Referring to FIG. 5, in operation 510, a peak power controlling apparatus determines whether a power consumption of a ZET is greater than or equal to a third threshold value.

In operation 520, in response to the power consumption being greater than or equal to the third threshold value, the peak power controlling apparatus determines control power such that an ESS releases energy stored therein. The third threshold value may be set to be a certain percentage, for example, 70%, of maximum peak power for a preset period of time. For example, the maximum peak power may be set to be maximum power among 15-minute average power values for recent one year. In this example, the ESS may be controlled from when 70% of recent maximum peak power is reached. The third threshold value may not be given as a constant, but be updated based on an actual power consumption of the ZET. For example, it may be continuously updated as time elapses based on a method of selecting a maximum value in a window.

According to an example embodiment, the peak power controlling apparatus determines control power at a current point in time based on at least one of a change in power consumption of the ZET, a result of the scheduling, a proportional constant, or control power of the ESS at an immediately preceding point in time.

In detail, in response to the power consumption being greater than or equal to the third threshold value, the peak power controlling apparatus may determine control power P_{ESS}(k) as represented by Equation 7.

P_{ESS}(k)=P_{ESS}(k−1)−G(k)[P_{TOWN}(k)−P_{TOWN}(k−1)]+[P_{SCH}(k)−P_{SCH}(k−1)] [Equation 7]

In Equation 7, P_{ESS}(k) denotes control power at a current point in time, and P_{ESS}(k−1) denotes control power at an immediately preceding point in time. G(k) denotes a proportional constant. P_{TOWN}(k) and P_{TOWN}(k−1) denote power of a ZET at the current point in time and at the immediately preceding point in time, respectively. P_{SCH}(k) and P_{SCH}(k−1) denote scheduled control power at the current point in time and at the immediately preceding point in time, respectively.

According to an example embodiment, the peak power controlling apparatus may determine the proportional constant based on a remaining capacity, or a state of charge (SOC), of the ESS.

In detail, the peak power controlling apparatus may determine G(k) based on an SOC L_{SOC} of the ESS and a proportional constant k, as represented by Equation 8.

$$G ( k ) = \{ \begin{matrix}{kL}_{SOC} & ( {P}_{TOWN} ( k ) > {P}_{TOWN} ( k - 1 ) ) \\ k ( 1 - {L}_{SOC} ) & ( others )\end{matrix} \qquad [ Equation 8 ]$$

When P_{TOWN}(k) increases, the peak power controlling apparatus may increase G(k) in proportion to L_{SOC}. Conversely, when P_{TOWN}(k) decreases, the peak power controlling apparatus may increase G(k) in proportion to (1−L_{SOC}).

Referring to Equation 7, the greater G(k), the faster convergence. Here, an SOC of the ESS may increase rapidly, and increase slowly otherwise. G(k) is controlled based on an SOC of the ESS, and thus the ESS may not be overcharged or fully discharged even though a capacity of the ESS is small.

In operation 530, in response to the power consumption being less than the third threshold value, the peak power controlling apparatus determines whether the power consumption is less than or equal to a fourth threshold value.

The fourth threshold value may be set to be a certain percentage, for example, 60%, of minimum peak power for a preset period of time. For example, the minimum peak power may be set to be minimum power among 15-minute average power values for recent one year. In this example, the ESS may be controlled from when 60% of recent maximum peak power is reached. The fourth threshold value may not be given as a constant, but be updated based on an actual power consumption of the ZET. For example, it may be continuously updated as time elapses based on a method of selecting a maximum value in a window.

In operation 540, in response to the power consumption being less than or equal to the fourth threshold value, the peak power controlling apparatus determines control power such that the ESS is charged.

In detail, the peak power controlling apparatus may determine control power P_{ESS}(k) of the ESS as represented by Equations 7 and 8.

In operation 550, in response to the power consumption not being greater than the third threshold value, and not being less than the fourth threshold value, the peak power controlling apparatus determines the control power P_{ESS}(k) to be P_{SCH}(k) determined based on Equation 5.

P_{TOWN} may increase when the ESS is charged based on the ESS, and decrease when the ESS releases energy stored therein from the ESS.

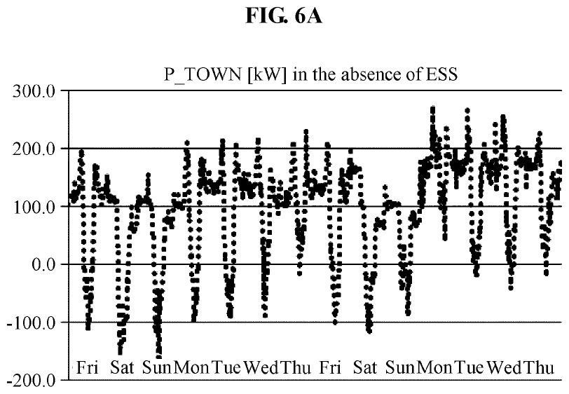

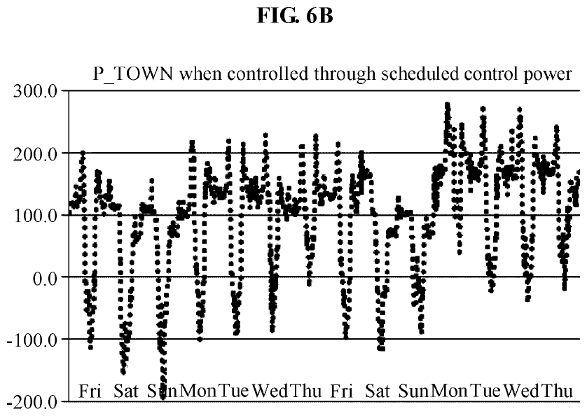

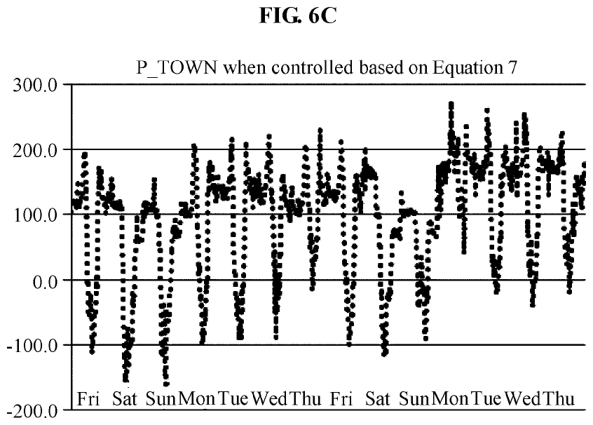

FIGS. 6A, 6B, and 6C are example graphs obtained by applying a peak power controlling method according to an example embodiment.

FIG. 6A illustrates a graph of P_{TOWN} based on a power consumption for two weeks and a result of controlling an ESS.

FIG. 6B illustrates a graph of P_{TOWN}obtained by applying control power of an ESS that is scheduled based on a time-varying electric rate, and FIG. 6C illustrates a graph of P_{TOWN} obtained by applying a result of controlling after applying scheduled control power and monitoring peak power.

In the graph of FIG. 6A, P_{TOWN} indicates a sum of an energy load and energy produced in a ZET. In a case of the sum being a positive value, the sum may indicate receiving energy from a grid. In a case of the sum being a negative value, the sum may indicate transmitting energy from the ZET to the grid.

In the graph of FIG. 6B, P_{TOWN} indicates a result obtained by applying scheduled control power. In the graph of FIG. 6B, P_{TOWN} indicates a sum of P_{TOWN} of FIG. 6A and P_{SCH}. Thus, in such illustrated example of FIG. 6B, peak power may increase.

As a result of controlling through control power based on Equation 7 as illustrated in FIG. 6C, it is verified that peak power is reduced compared to the example illustrated in FIG. 6B.

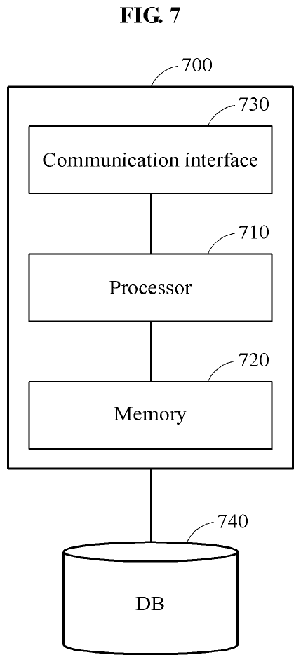

FIG. 7 is a diagram illustrating an example of a peak power controlling apparatus according to an example embodiment.

Referring to FIG. 7, a peak power controlling apparatus 700 includes a processor 710, a memory 720, and a communication interface 730. According to an example, the peak power controlling apparatus 700 may further include a database (DB) 740.

The memory 720 may be connected to the processor 710, and configured to store instructions executable by the processor 710, and data to be processed by the processor 710 or data processed by the processor 710. The memory 720 may include a non-transitory computer readable medium such as, for example, a high-speed random access memory (RAM) and/or a nonvolatile computer readable storage medium (e.g., one or more disk storage devices, flash memory devices, or other nonvolatile solid state memory devices).

The communication interface 730 may provide an interface for communication with an external device, for example, a user terminal. The communication interface 730 may communicate with the external device through a wired or wireless network.

The DB 740 may store information and data that is needed to operate the peak power controlling apparatus 700. For example, the DB 740 may store time-varying electric rate information, threshold values needed to calculate control power, and the like.

The processor 710 may perform one or more operations described above in relation to the peak power controlling apparatus 700 with reference to FIGS. 1 through 6. For example, the processor 710 may schedule control power of an ESS for each time period based on time-varying electric rate information of a grid, monitor a power consumption of a ZET, and determine control power of the ESS based on a result of the scheduling and a result of comparing the power consumption of the ZET and a preset threshold value.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A peak power controlling method for a zero energy town (ZET), comprising:
scheduling control power of an energy storage system (ESS) based on time-varying electric rate information of a grid;
monitoring a power consumption of the ZET; and
determining control power of the ESS based on a result of the scheduling and a result of comparing the power consumption of the ZET and a preset threshold value.

2. The peak power controlling method of claim 1, wherein the scheduling comprises:
scheduling the control power to charge the ESS in a time period in which an electric rate is less than or equal to a first threshold value.

3. The peak power controlling method of claim 2, wherein the scheduling comprises:
scheduling the control power to discharge the ESS in a time period in which the electric rate is greater than or equal to a second threshold value.

4. The peak power controlling method of claim 1, wherein the determining of the control power comprises:
in response to the power consumption being greater than or equal to a third threshold value, determining the control power such that the ESS releases energy stored therein.

5. The peak power controlling method of claim 1, wherein the determining of the control power comprises:
in response to the power consumption being less than or equal to a fourth threshold value, determining the control power such that the ESS is charged.

6. The peak power controlling method of claim 1, wherein the determining of the control power comprises:
in response to the power consumption being less than a third threshold value and greater than a fourth threshold value, determining the control power based on the result of the scheduling.

7. The peak power controlling method of claim 1, wherein the determining of the control power comprises:
determining the control power based on at least one of a change in power consumption, the result of the scheduling, a proportional constant, or power of the ESS at an immediately preceding point in time.

8. The peak power controlling method of claim 7, wherein the proportional constant is determined based on a state of charge (SOC) of the ESS.

9. A peak power controlling apparatus configured to control peak power of a zero energy town (ZET) and a grid, comprising:
a memory; and
a processor,
wherein the processor is configured to:
schedule control power of an energy storage system (ESS) based on time-varying electric rate information of the grid;
monitor a power consumption of the ZET; and
determine control power of the ESS based on a result of the scheduling and a result of comparing the power consumption of the ZET and a preset threshold value.

10. The peak power controlling apparatus of claim 9, wherein the processor is configured to schedule the control power to charge the ESS in a time period in which an electric rate is less than or equal to a first threshold value.

11. The peak power controlling apparatus of claim 10, wherein the processor is configured to schedule the control power to discharge the ESS in a time period in which the electric rate is greater than or equal to a second threshold value.

12. The peak power controlling apparatus of claim 9, wherein, in response to the power consumption being greater than or equal to a third threshold value, the processor is configured to determine the control power such that the ESS releases energy stored therein.

13. The peak power controlling apparatus of claim 9, wherein, in response to the power consumption being less than or equal to a fourth threshold value, the processor is configured to determine the control power such that the ESS is charged.

14. The peak power controlling apparatus of claim 9, wherein, in response to the power consumption being less than a third threshold value and greater than a fourth threshold value, the processor is configured to determine the control power based on the result of the scheduling.

15. The peak power controlling apparatus of claim 9, wherein the processor is configured to determine the control power based on at least one of a change in power consumption, the result of the scheduling, a proportional constant, or power of the ESS at an immediately preceding point in time.

16. The peak power controlling apparatus of claim 9, wherein the proportional constant is determined based on a state of charge (SOC) of the ESS.
